(19) United States
(12) Patent Application Publication
(10) Pub. No.: US 2009/0001055 A1
(43) Pub. Date: Jan. 1, 2009

(54) Method and apparatus for control of resistance brazing

(75) Inventors: Tadashi Kawagoe, Oobu-city (JP); Kazuyoshi Suzuki, Chita-gun (JP); Hajime Fushimoto, Chiryu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/215,595

(22) Filed: Jun. 26, 2008

(30) Foreign Application Priority Data
Jun. 28, 2007 (JP) 2007-170669

(51) Int. Cl. B23K 1/00

(52) U.S. Cl. 219/85.22; 219/85.1

(57) ABSTRACT

An apparatus for control of resistance brazing is provided in a resistance brazing apparatus which grips parts of a weld object between which a brazing material is interposed between a pair of electrodes, applies pressure to the parts of the weld object, and feeds power to said electrodes in that state for resistance brazing, including a power feed time measurement unit measuring a power feed time to said electrodes required from when an amount of displacement of a distance between the pair of electrodes reaches a first amount of displacement to when it reaches a second amount of displacement and a control unit decreasing the amount of power feed to the pair of electrodes when the power feed time is a lower limit threshold value or less and increasing the amount of power feed to the electrodes when the power feed time is the upper limit threshold value or more.

The applicant claims the right to priority based on Japanese Patent Application No. 2007-170669, filed on Jun. 28, 2007, the entire content of which is hereby incorporated by reference.

### BACKGROUND OF THE INVENTION

1. Field of the Invention

The present invention relates to a method and apparatus for control of resistance brazing, more particularly relates to a method and apparatus for control of resistance brazing which controls the amount of heat generated.

Further, the present invention relates to a method of production of a copper product by resistance brazing, more particularly relates to method of production of a copper product performing resistance brazing using the method for control of resistance brazing.

2. Description of the Related Art

In the past, resistance brazing has been used for welding various weld objects. Resistance brazing interposes a brazing material between separated parts of a weld object and grips the parts of the weld object with the brazing material interposed between them between a pair of electrodes. Next, it applies pressure to the weld object, feeds power to the electrodes in that state, and uses the contact resistance between the electrodes and weld object to generate heat to melt the brazing material and weld the separated parts of the weld object by brazing. Such resistance brazing is particularly utilized in the case of desiring to locally heat the weld object or in the case of desiring to join the parts in a short time. Further, the welding parts of the weld object are not always flat, but are sometimes curved.

In resistance brazing, a large current flows to the electrodes. Furthermore, along with the electrodes being repeatedly used, the electrodes oxidize and degrade and cracks sometimes occur. If these cracks grow, the contact resistance between the electrodes and the weld object increases. Further, the electrodes sometimes deteriorate along with time resulting in the contact resistance between the electrodes and the weld object decreasing.

If the contact resistance between the electrodes and weld object increase or decrease in this way, the electrodes are fed a constant current of a predetermined value, so the amount of heat generated by the contact resistance fluctuates increasing or decreasing. As a result, the behavior by which the brazing material melts changes and the worked state of the brazing is liable to become unstable. Furthermore, various improved methods have been proposed for welding using brazing.

For example, Japanese Patent Publication (A) No. 61-219769 proposes a method of joining a ceramic and a metal by detecting displacement resulting in the thickness of the brazing material being reduced. In resistance brazing, the electrodes can deform and be crushed along with aging of the electrodes, but it is difficult to judge the change in the contact resistance by just detecting displacement of the thickness of the weld object.

Further, Japanese Patent Publication (A) No. 2004-241574 proposes the method of repair of an electronic device improving the quality of a solder bond of a remounted part and discloses a method of measurement of solder height using a laser displacement meter. However, as explained above, it is difficult to judge the change in contact resistance just by detecting the displacement of thickness of the weld object.

Further, Japanese Patent Publication (A) No. 61-219769 and Japanese Patent Publication (A) No.2004-241574 do not describe the method of holding the amount of heat generated constant even if the contact resistance changes.

### SUMMARY OF THE INVENTION

The present invention was made to solve the above problem and has as its object the provision of a method and apparatus for controlling resistance brazing maintaining the amount of heat generated constant even if the contact resistance or other interelectrode resistance changes. Further, the present invention has as its object the provision of a method of production of a copper product using this method of control of resistance brazing to perform resistance brazing. Here, the “interelectrode resistance” includes contact resistance between the electrodes and weld object and the electrical resistance inherent to the electrodes themselves.

To achieve this object, the method according to the present invention is a method of control of resistance brazing comprising gripping parts of a weld object (41, 42) between which a brazing material (43) is interposed between a pair of electrodes (31, 32), applying pressure to the parts of the weld object (41, 42), and applying power to the electrodes (31, 32) in that state, which method comprises measuring a power feed time (T) to the electrodes (31, 32) required from when an amount of displacement of a distance between a pair of the electrodes (31, 32) reaches a first amount of displacement to when it reaches a second amount of displacement, decreasing the amount of power feed to the pair of electrodes (31, 32) when the power feed time (T) is a lower limit threshold value or less, and increasing the amount of power feed to the electrodes (31, 32) when the power feed time (T) is the upper limit threshold value or more.

Due to this, even if the interelectrode resistance changes, it is possible to maintain the amount of heat generated constant when performing resistance brazing.

Further, in the method according to the present invention, preferably the first amount of displacement corresponds to the time when the brazing material (43) starts to melt, while the second amount of displacement corresponds to the time when the brazing material (43) completely melts and spreads over the welding parts of the parts of the weld object (41, 42).

Due to this, the characteristic time required from when the brazing material (43) starts to melt to when it completely melts can be made the power feed time (T).

Further, in the method according to the present invention, preferably the lower limit threshold value is made the value of an average value of the power feed time (T) found by performing resistance brazing with the brazing material (43) interposed between the parts of the weld object (41, 42) a plurality of times minus the value of the standard deviation of the power feed time (T) multiplied by three.

Due to this, the brazing material (43) can be completely melted.

Further, in the method according to the present invention, preferably the upper limit threshold value is made the value of an average value of the power feed time (T) found by performing resistance brazing with the brazing material (43) interposed between the parts of the weld object (41, 42) a plurality of times plus the value of the standard deviation of the power feed time (T) multiplied by four.

Due to this, the brazing material (43) can be completely melted and the parts of the weld object (41,42) can be prevented from receiving unnecessary deformation.

Further, in the method according to the present invention, preferably the method changes the current flowing through the pair of the electrodes (31,32) to control the amount of heat generated.

Due to this, it is possible to maintain the amount of heat generated during the resistance brazing constant.

Further, in the method according to the present invention, preferably the pair of electrodes (31, 32) is comprised of a fixed electrode (31) and a movable electrode (32), and the power feed time (T) to the electrodes required from when the amount of displacement of the movable electrode (32) reaches the first amount of displacement to when it reaches the second amount of displacement is measured.

Further, the apparatus according to the present invention is an apparatus for control of resistance brazing which grips parts of a weld object (41, 42) between which a brazing material (43) is interposed between a pair of electrodes (31, 32), applies pressure to the parts of the weld object (41, 42), and feeds power to the electrodes (31, 32) in that state for resistance brazing, including a power feed time measurement unit (12) measuring a power feed time (T) to the electrodes (31, 32) required from when an amount of displacement of a distance between the pair of electrodes (31, 32) reaches a first amount of displacement to when it reaches a second amount of displacement and a control unit (11) decreasing the amount of power feed to the pair of electrodes (31, 32) when the power feed time (T) is a lower limit threshold value or less and increasing the amount of power feed to the electrodes (31, 32) when the power feed time (T) is the upper limit threshold value or more.

Due to this, even if the interelectrode resistance changes, it is possible to maintain the amount of heat generated constant when performing the resistance brazing.

Further, the method according to the present invention is a method of production of a copper product comprising gripping copper parts (41, 42) between which a brazing material (43) is interposed between a pair of electrodes (31, 32), applying pressure to the copper parts (41, 42), and feeding power to the electrodes (31, 32) in that state for resistance brazing, comprising using the above method of control of the resistance brazing when performing resistance brazing.

Due to this, it is possible to perform the resistance brazing maintaining the amount of heat generated constant to produce a good quality copper product.

Note that the notations in parentheses after the above means are examples showing correspondence with specific means described in the embodiments explained below.

### BRIEF DESCRIPTION OF THE DRAWINGS

These and other features and advantages of the present invention will be better understood by reading the following detailed description taken together with the drawings, wherein:

FIG. 1 is a view of the configuration of a resistance brazing apparatus provided with an apparatus for control of resistance brazing of an embodiment of the present invention;

FIG. 2 is a block diagram of the functions of an apparatus for control of resistance brazing of FIG. 1;

FIG. 3 is a view for explaining a program for selecting a current value included in a constant current source;

FIG. 4 is a view showing the process by which copper parts are resistance brazed;

FIG. 5 is a view showing the relationship between the amount of displacement of a movable electrode and an elapsed time of power feed to the electrode;

FIG. 6 is a view showing the power feed times in the case with a brazing material and the case without a brazing material found from FIG. 5;

FIG. 7A is a first part of a flow chart showing the routine of a method of control of resistance brazing of the present invention;

FIG. 7B is a second part of a flow chart showing the routine of a method of control of resistance brazing of the present invention; and

FIG. 8 is another view for explaining a program for selecting a current value built into the constant current source.

### DESCRIPTION OF THE PREFERRED EMBODIMENTS

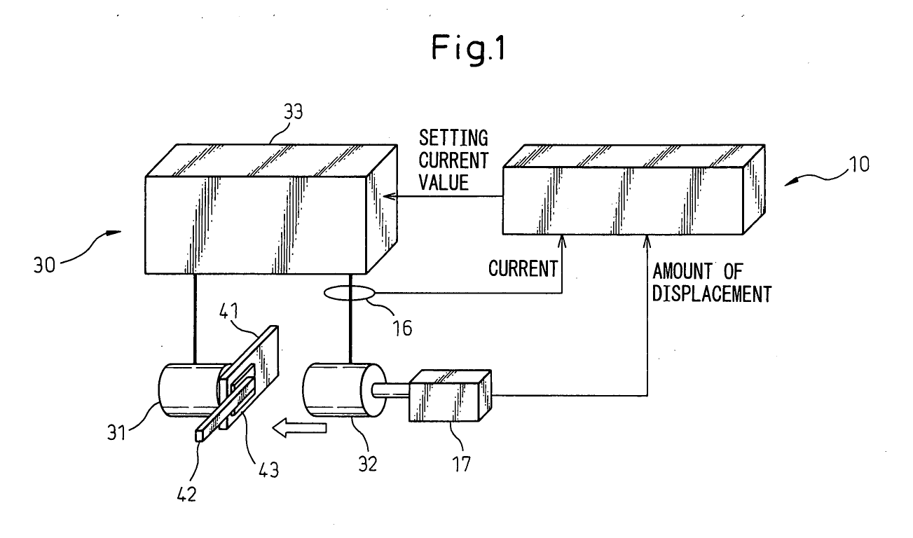

Below, an apparatus for control of resistance brazing of the present invention will be explained based on a preferable embodiment with reference to FIG. 1 to FIG. 6. However, note that the present invention is not limited by the following explanation and that it extends to the aspects of the invention described in the claims and their equivalents.

FIG. 1 is a view of the configuration of a resistance brazing apparatus 30 provided with an apparatus 10 for control of resistance brazing of an embodiment of the present invention (hereinafter also simply referred to as “the apparatus 10”). The resistance brazing apparatus 30 is an apparatus for producing a copper product used as a component of an alternator. This apparatus 30, as shown in FIG. 1, grips parts of a weld object between which a brazing material 43 is interposed, that is, copper parts 41, 42, between a pair of electrodes 31, 32, applies pressure to the copper parts 41, 42, and feeds power to the electrodes 31, 32 in that state for resistance brazing.

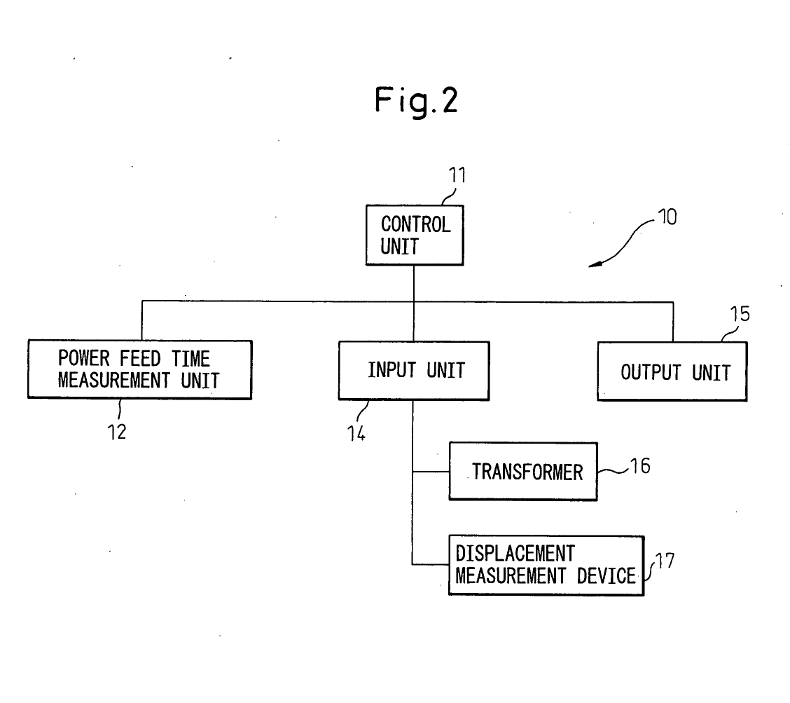

The apparatus 10 controls the amount of heat generated by the resistance brazing performed by the resistance brazing apparatus 30. The apparatus 10, as shown in FIG. 1 and FIG. 2, has a power feed time measurement unit 12 measuring a power feed time T to the electrodes 31, 32 required from when an amount of displacement of a distance between the pair of electrodes 31, 32 reaches a first amount of displacement to when it reaches a second amount of displacement and a control unit 11 decreasing the amount of power feed to the pair of electrodes 31, 32 when the power feed time T is a lower limit threshold value Tb or less and increasing the amount of power feed to the electrodes 31, 32 when the power feed time T is the upper limit threshold value Ta or more.

Further, the apparatus 10 has a transformer 16 measuring the value of current flowing between the pair of electrodes 31, 32 and outputting the measured current value, a displacement measurement device 17 measuring the amount of displacement of the distance between the pair of electrodes 31, 32 and outputting the measured amount of displacement, an input unit 14 receiving as input the current value output by the transformer 16 and the amount of displacement output by the displacement measurement device 17, and an output unit 15 outputting the results of control by the control unit 11.

The weld object brazed by the resistance brazing apparatus 30 is, as shown in FIG. 1, comprised of one copper part 41 and another copper part 42. The one copper part 41 is a flat plate of a vertically long rectangular shape when viewed planarly. Further, the other copper part 42 is a bar having a vertically long parallelepiped shape.

The copper part 42, as shown in FIG. 1, is resistance brazed at one end in the longitudinal direction to the copper part 41 at one end in the longitudinal direction. Further, before resistance brazing, a brazing material 43 is interposed between the copper part 41 and the copper part 42. This brazing material 43 is used to temporarily fasten the copper part 41 and the copper part 42, then fix the copper parts to the electrodes.

As the brazing material 43 used in the resistance brazing apparatus 30, any known brazing material suitable for welding the copper parts of a weld object may be used without any particular limitation. The temperature at which the brazing material melts is lower than the melting point of the weld object. The melting point of copper is 1000° C. or more, so it is preferable to use a brazing material melting at about 800° C.

Next, the resistance brazing apparatus 30 will be explained further below. The resistance brazing apparatus 30 has a pair of electrodes 31, 32 and a constant current source 33 feeding current to the electrodes 31, 32. With resistance brazing, the contact resistance between the electrodes fed power by the constant current source 33 and the weld object results in the generation of resistance heat, the heated brazing material 43 melts, and the separated parts of the weld object are brazed.

The pair of electrodes 31, 32 is comprised of a fixed electrode 31 and a movable electrode 32. The fixed electrode 31 and the movable electrode 32 are brazed to not shown electrode holders to be fixed to the electrode holders. These electrode holders are electrically connected to the constant current source 33.

The movable electrode 32 is driven by a not shown drive apparatus to press the copper parts 41, 42 arranged between the fixed electrode 31 and movable electrode 32 by a predetermined pressure. As the drive apparatus, for example, an air cylinder can be used.

The fixed electrode 31 has a not shown jig. The copper part 41 to which the copper part 42 is temporarily attached is fastened detachably to the fixed electrode 31 using this jig.

The parts of the fixed electrode 31 and movable electrode 32 supporting the weld object are preferably shaped to easily support the weld object. The parts of the weld object, that is, the copper part 41 and the copper part 42, as shown in FIG. 1, have flat portions, so the parts of the fixed electrode 31 and movable electrode 32 supporting the weld object are shaped flat.

Further, as the material forming the fixed electrode 31 or movable electrode 32, for example, tungsten or a tungsten alloy of an alloy of copper and tungsten is preferably used.

At the time of resistance brazing, the fixed electrode 31 and movable electrode 32 fed with power grip copper parts 41, 42 between which a brazing material 43 is interposed. The movable electrode 32 is pressed to the fixed electrode 31 by a predetermined pressure so that the distance between the two electrodes 31, 32 is shortened. Furthermore, the movable electrode 32 is gradually moved. The pressure on the movable electrode 32 is stopped when the amount of displacement reaches a predetermined amount of displacement. This predetermined amount of displacement is the maximum amount of displacement over which the movable electrode 32 moves. Below, this maximum amount of displacement will be referred to as the “set amount of displacement”. Note that the power feed to the electrodes is preferably stopped right before the pressure on the movable electrode 32 is stopped.

In resistance brazing, the set amount of displacement for stopping pressure on the movable electrode 32 can for example be set as follows.

If applying predetermined pressure to the copper parts 41, 42 between which the brazing material 43 is interposed between the power fed pair of electrodes 31, 32, the brazing material 43 melts and the movable electrode 32 gradually moves and approaches the fixed electrode 31. Furthermore, the pressure on the movable electrode 32 is stopped when the amount of displacement of the movable electrode 32 reaches certain amount of displacement. In the same way, the amount of displacement for stopping pressure to the movable electrode 32 is set to a plurality of levels for the resistance brazing.

Next, the bond strength of the copper part 41 and the copper part 42 brazed together is examined for copper parts welded by different amounts of displacement. The bond strength is examined for the planar direction of the welding surfaces and the direction vertical to the welding surfaces. Furthermore, the welded copper parts are given a bond strength of at least the bond strength sought. The amount of displacement giving a bond strength with a certain margin of safety with respect to the bond strength sought is made the set amount of displacement of the movable electrode 32.

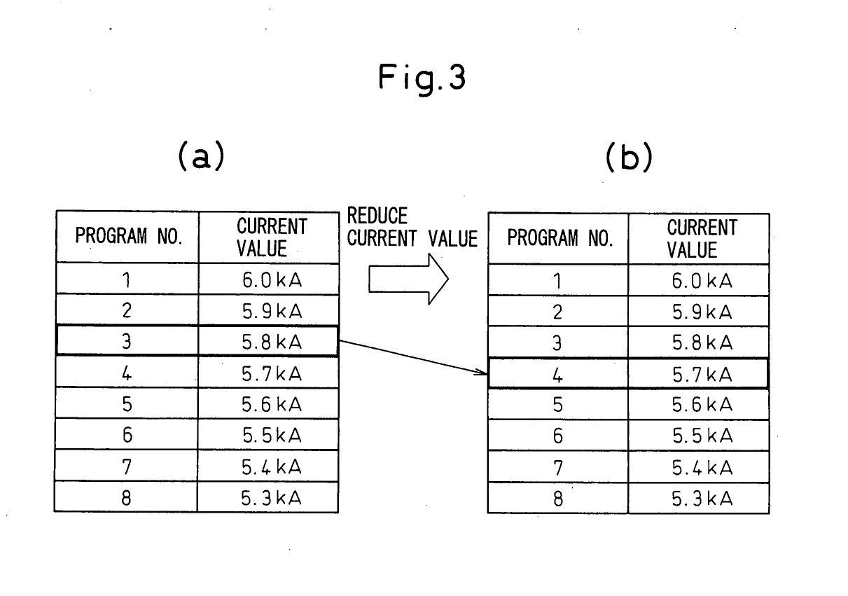

The constant current source 33 supplies an AC constant current to the fixed electrode 31 and movable electrode 32. The constant current source 33 measures the value of the current which it outputs itself and uses the measured current value for feedback control of the value of the output current. The constant current source 33, as shown in FIG. 3(a), outputs a predetermined value of current by selection of the built in program. The program built into the constant current source 33 can be selected and set by the control unit 11 of the apparatus 10 for control of resistance brazing.

The apparatus 10, as will be explained later in detail, takes note of the behavior when the brazing material 43 is melting, holds the amount of heat generated constant at all times, and holds the state of melting of the brazing material 43 constant. Furthermore, the apparatus 10 changes the value of the current flowing to the pair of electrodes 31, 32 to control the amount of heat generated.

The contact resistance between the electrodes and the weld object sometimes changes along with aging of the electrodes. This contact resistance sometimes increases and sometimes decreases. The electrodes are sent a constant current, so if the contact resistance increases, the amount of heat generated increases. On the other hand, if the contact resistance decreases, the amount of heat generated decreases. Therefore, the amount of heat generated sometimes changes due to aging of the electrodes.

Further, the fixed electrode 31 or movable electrode 32 sometimes changes in the value of the current flowing to the electrode due to the state of brazing to the electrode holder. Therefore, when replacing the electrodes with new ones, the amount of heat generated sometimes changes due to the state of brazing.

Therefore, the apparatus 10 controls the value of the current output by the constant current source 33 when replacing electrodes or in accordance with the deterioration of the electrodes along with time in order to maintain the amount of heat generated constant at all times.

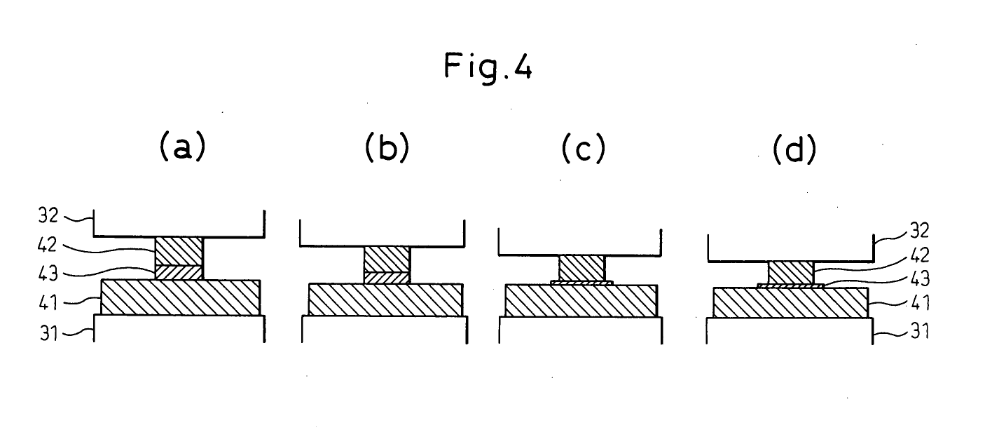

Next, FIGS. 4(a) to 4(d) show the process by which the copper part 41 and the copper part 42 are resistance brazed. First, as shown in FIG. 4(a), the copper parts 41, 42 temporarily fastened by the interposition of the brazing material 43 are gripped between the fixed electrode 31 and the movable electrode 32.

Next, the fixed electrode 31 and movable electrode 32 are powered and, as shown in FIG. 4(b), the movable electrode 32 starts to be pressed toward the fixed electrode 31 by a predetermined pressure. The copper part 41, the copper part 42, and the interposed brazing material 43 are heated by the heat generation and pressed to start to deform.

Furthermore, as shown in FIG. 4(c), when reaching the temperature where the brazing material 43 melts, the brazing material 43 starts to melt. The brazing material 43 completely melts and is thinly spread over the welding surfaces of the copper parts 41, 42. Note that the temperature caused by this heat generation is preferably controlled to become lower than the melting point of the weld object, that is, the copper parts 41, 42.

Furthermore, as shown in FIG. 4(d), to make the welding more reliable, the copper parts 41, 42 are pressed until deforming by a predetermined amount and the movable electrode 32 moves. After reaching the set amount of displacement, the pressure on the movable electrode 32 is stopped. The power feed to the electrodes is stopped right before the movable electrode 32 reaches the set amount of displacement. Suitably thereafter, the brazing material 43 falls in temperature and the brazing material 43 solidifies whereby a copper product comprised of the copper part 41 and the copper part 42 brazed together by the solidified brazing material 43 is obtained.

The apparatus 10 controls the resistance brazing so as to maintain constant the amount of heat generated applied to the brazing material 43 interposed between the copper part 41 and the copper part 42 in the above resistance brazing. Next, the thinking behind the control method of the apparatus 10 will be explained below.

As shown in FIG. 4(b) and FIG. 4(c), around when the brazing material 43 melts, the thickness of the brazing material 43 greatly changes. This change of the thickness of the brazing material 43 can be measured as the amount of displacement of the moving movable electrode 32. That is, the movable electrode 32 becomes particularly large in the amount of displacement per unit time while the brazing material 43 is melting compared with before the brazing material 43 starts to melt and when the brazing material 43 has finished melting completely.

On the other hand, when the brazing material 43 is not arranged between the copper part 41 and the copper part 42, heating and pressure cause the copper parts to deform, but rapid displacement of the movable electrode 32 like in the case where the brazing material 43 melts does not occur.

Therefore, if controlling the operation so that the behavior of the brazing material 43 being heated and melting can be repeated with good reproducibility, it becomes possible to make the amounts of heat generated at the pair of electrodes 31, 32 constant. That is, the current fed is controlled so that the time required from when the brazing material 43 starts to melt to when the brazing material 43 completely melts and spreads over the welding parts of the copper parts 41, 42 becomes substantially constant. Furthermore, this time when the brazing material 43 starts to melt and the time when the brazing material 43 completely melts and spreads over the welding parts of the copper parts 41, 42 can be learned, as explained later, from the amount of displacement of the movable electrode 23.

Next, the constitution of the apparatus 10 will be explained further below and the control method of the apparatus 10 will be explained in detail.

The control unit 11 of the apparatus 10, as shown in FIG. 2, controls the power feed time measurement unit 12, input unit 14, and output unit 15. Further, the control unit 11 maintains the amount of heat generated at the electrodes constant at all times by controlling the value of the current output from the constant current source 33. The control unit 11 measures the value of the current output from the constant current source 33. The control unit 11 examines if a value of current as set in the constant current source 33 is being output and confirms that the constant current source 33 is operating normally.

The control unit 11 issues an instruction to the constant current source 33 to start the power feed to the electrodes 31, 32 simultaneously with the movable electrode 32 starting to apply pressure to the copper parts 41, 42. Further, the control unit 11 measures the amount of displacement of the movable electrode 32 by the input unit 14 in synchronization with the AC frequency of the current output by the constant current source 33 and makes the power feed time measurement unit 12 measure that time.

The apparatus 10 changes the value of the current fed to the electrodes 31, 32 to control the amount of heat generated. If the amount of heat generated is Q, the current value is I, the contact resistance of the electrodes and copper parts is R, and the power feed time is T, the amount of heat generated Q is expressed as follows where A is a proportional constant:

Q=A×I²×R×T

so by changing the current value I, it is possible to control the amount of heat generated over a wide range. Further, it is also possible to control the pressure applied to the movable electrode 32 to change the contact resistance R and thereby control the amount of heat generated.

The input unit 14, as shown in FIG. 2, has a transformer 16 and a displacement measurement device 17. The input unit 14 receives as input the value of the current of the constant current source 33 output by the transformer 16. Further, the input unit 14 receives as input the amount of displacement of the movable electrode 32 output by the displacement measurement device 17. Further, the input unit 14 has a not shown keyboard or mouse or other input device and enables the input of the threshold value used for the quality judgment or other parameters to the apparatus 10.

On the power line by which the constant current source 33 outputs current to the movable electrode 32, as shown in FIG. 1, the transformer 16 is arranged. The transformer 16 measures the value of the current flowing over the power line and outputs the measured current value to the input unit 14. The transformer 16 outputs the large current flowing over the power line converted to, for example, a small current or voltage.

The displacement measurement device 17 measures the amount of displacement of the movable electrode 32 and outputs the measured amount of displacement to the input unit 14. The input unit 14 outputs the input amount of displacement of the movable electrode 32 to the power feed time measurement unit 12. As the displacement measurement device 17, it is preferable to use a type not affected by the magnetic field generated by the large current flowing through the movable electrode 32. The apparatus 10, as the displacement measurement device 17, uses a contact type probe detecting the amount of displacement of the movable electrode 32 and a linear gauge reading the amount of displacement of the probe optically.

The power feed time measurement unit 12 measures the elapsed time of the power feed from when the constant current source 33 starts to feed power to the pair of electrodes 31, 32 to when it ends the power feed. Specifically, the power feed time measurement unit 12, as explained above, receives as input the amount of displacement of the movable electrode 32 measured in synchronization with the AC frequency of the current output by the constant current source 33 and stores this amount of displacement along with the elapsed time of the power feed. Furthermore, the power feed time measurement unit 12 finds the power feed time T to the electrodes required from when the amount of displacement of the movable electrode 32 reaches the first amount of displacement to when it reaches the second amount of displacement from the stored measurement data.

While explained in detail later, the first amount of displacement in the apparatus 10 corresponds to the time when the brazing material 43 starts to melt. Furthermore, the second amount of displacement corresponds to the time, after the brazing material 43 starts to melt, when the brazing material 43 completely melts and spreads over the welding parts of the copper parts 41, 42.

Further, the time when the constant current source 33 starts to feed power to the pair of electrodes 31, 32 and the time when it finishes feeding the power are judged by the power feed time measurement unit 12 from the value of the current input to the input unit 14.

The control unit 11 decreases the amount of power feed to the pair of electrodes 31, 32 when the power feed time T is a lower limit threshold value Tb or less and increases the amount of power feed to the electrodes 31, 32 when the power feed time T is the upper limit threshold value Ta or more. While explained in more detail later, the apparatus 10 makes the lower limit threshold value Tb the value of an average value of the power feed time T found by performing resistance brazing with the brazing material 43 interposed between the parts of the weld object 41, 42 a plurality of times minus the value of the standard deviation of the power feed time T multiplied by three. Further, the apparatus 10 makes the upper limit threshold value Ta the value of an average value of the power feed time T found by performing resistance brazing with the brazing material 43 interposed between the parts of the weld object 41, 42 a plurality of times plus the value of the standard deviation of the power feed time T multiplied by four.

In the specification, the “power feed time T being the lower limit threshold value Tb or less” includes the case where the power feed time T being equal to the lower limit threshold value Tb. Further, the “power feed time T being the upper limit threshold value Ta or more” includes the case where the power feed time T being equal to the upper limit threshold value Ta.

The output unit 15, while not shown, has for example a display, printer, or other output device and outputs the results of judgment by the control unit 11. Specifically, the output unit 15 outputs the fact that the copper product is a good product when the amount of heat generated in the resistance brazing is within a predetermined range, while outputs the fact that the copper product is a defective product when the amount of heat generated is not inside the predetermined range.

If the power feed time T is the lower limit threshold value Tb or less or the power feed time T is the upper limit threshold value Ta or more, that copper part is preferably removed from the production process as a defective product. Further, the control unit 11 instructs the current value output through the output unit 15 to the constant current source 33 to change the setting of the output current value.

The above-mentioned apparatus 10 can be realized, for example, by using a personal computer provided with an input/output interface. That is, the hardware configuration of the apparatus 10, for example, may be a central processing unit (CPU), numerical processor, ROM or RAM or other semiconductor memory, magnetic storage medium or optical storage medium, input/output interface, etc. The processing for control of the amount heat generated performed by the apparatus 10 etc. are realized by the central processing unit (CPU) or numerical processor running a predetermined program stored in the magnetic storage medium or optical storage medium.

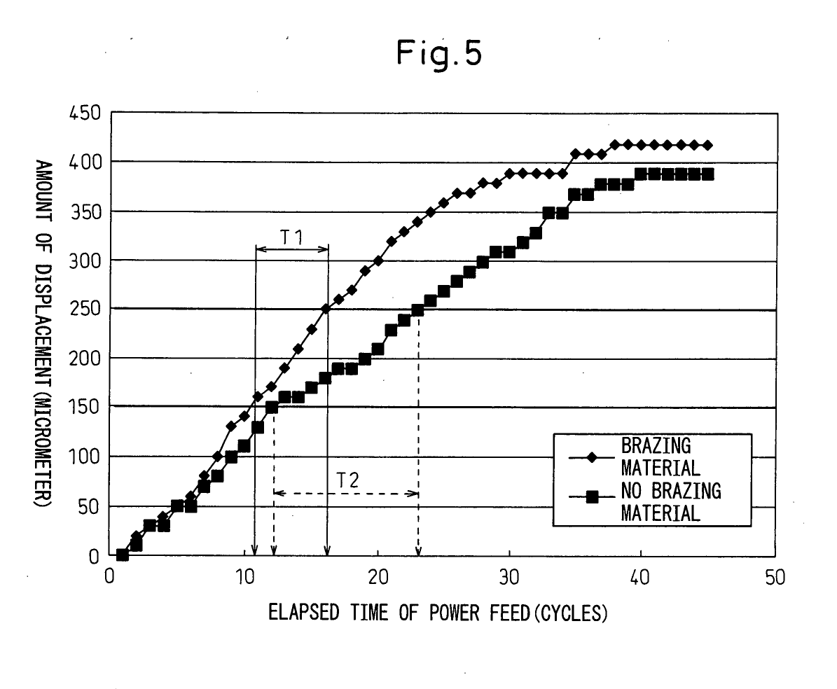

Next, the relationship between the amount of displacement of the movable electrode 32, measured using the resistance brazing apparatus 30 provided with the above-mentioned apparatus 10, and the elapsed time of the power feed to the electrodes will be explained below with reference to FIG. 5.

FIG. 5 shows the relationship between the amount of displacement of the movable electrode 32 and the elapsed time in power feed to the electrodes when performing the resistance brazing using the apparatus shown in FIG. 1. FIG. 5 shows the result of measurement in the case of using a brazing material in resistance brazing interposing a brazing material 43 between the copper parts 41, 42 and the result of measurement in the case of not using a brazing material in resistance brazing without interposing a brazing material between the copper parts 41, 42.

The ordinate of the FIG. 5 shows the amount of displacement of the movable electrode 32 after the start of applying pressure to the movable electrode 32. The points are measured in synchronization with the AC frequency of the current output by the constant current source 33. That is, the amount of displacement of the movable electrode 32 is measured for each cycle of the AC frequency.

The abscissa of FIG. 5 shows the elapsed time of power feed after the start of power feed to the electrodes. The time when power starts to be fed to the electrodes is simultaneous with the time when pressure starts to be applied to the movable electrode 32, so the abscissa shows the elapsed time of power feed required for the movable electrode 32 to move by that amount of displacement. This elapsed time of power feed has as its unit one cycle of the AC waveform of the current output by the constant current source 33. In the example of FIG. 5, the constant current source 33 is supplied with a 60 Hz AC power. The current output by the constant current source 33 to the electrodes is similarly 60 Hz AC. That is, this one cycle corresponds to about 16.7 msec.

If comparing the measurement plots in the case of a brazing material and in the case of no brazing material, until the about 10th cycle, the changes in the amounts of displacement of the two along with time are substantially the same. This amount of displacement is believed to be mainly due to the deformation of the copper parts 41, 42 and the brazing material 42 due to the heating and pressure.

On the other hand, from about the 10th cycle, the amount of displacement in the case of a brazing material starts to become larger compared with the case of no brazing material. A difference starts to arise in the amount of displacement between the two. This is because along with the increase of the elapsed time of power feed, the temperature of the heated brazing material 43 increases and the brazing material 43 starts to melt. Along with the melting of this brazing material 43, the displacement of the movable electrode 32 becomes larger.

Therefore, in the apparatus 10, to examine for the power feed time giving the amount of heat generated by which the brazing material 43 completely melts, the period from when the brazing material 43 starts to melt to when the brazing material 43 completely melts and spreads over the welding parts of the copper parts 41, 42 is focused on.

Using the apparatus shown in FIG. 1, the behavior of the brazing material 43 melting during resistance brazing was photographed and examined. As a result, in the example of FIG. 5, it was learned that the time when the brazing material 43 starts to melt corresponds to an amount of displacement of 150 micronmeter, while the time when the brazing material 43 completely melts and spreads over the welding parts of the copper parts 41, 42 corresponds to an amount of displacement of 250 micronmeter.

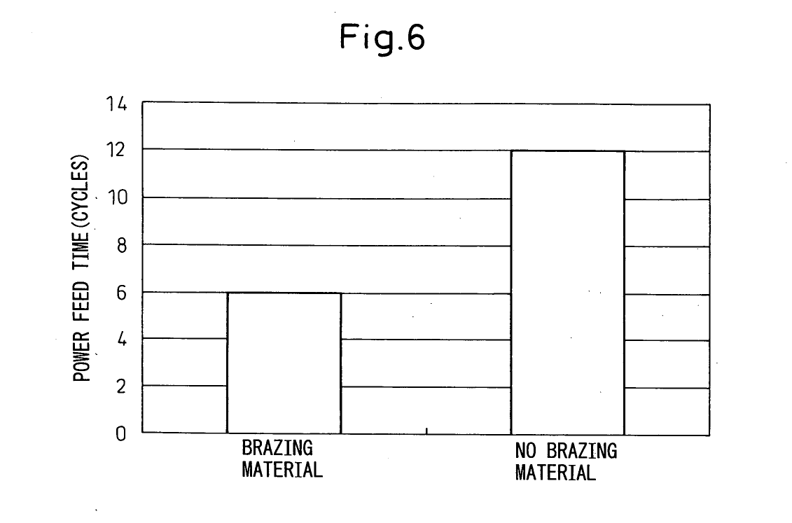

In the case of use of a brazing material, the power feed time T1 required for the amount of displacement to change from 150 micronmeter to 250 micronmeter was, as shown in FIG. 6, 6 cycles. Further, in the case of no brazing material, the power feed time T2 required for the amount of displacement to change from 150 micronmeter to 250 micronmeter was 12 cycles. That is, the power feed time T1 in the case of use of a brazing material was about 100 msec, while the power feed time T2 in the case of no brazing material was about 200 msec.

In this way, the power feed time T1 in the case of use of a brazing material is half of the power feed time T2 in the case of no brazing material. It was learned that the power feed times of the two greatly differ. That is, it was learned that the value of the power feed time required for the amount of displacement to change from 150 micronmeter to 250 micronmeter means the characteristic time required from when the brazing material 43 starts to melt to when it completely melts.

Therefore, as explained above, the apparatus 10 deems that the first amount of displacement of the movable electrode 32, in the example of FIG. 5, 150 micronmeter, corresponds to the time when the brazing material 43 starts to melt in the case where the brazing material 43 is interposed between the copper parts 41, 42. Furthermore, it deems that the second amount of displacement of the movable electrode 32, in the example of FIG. 5, 250 micronmeter, corresponds to the time when, after the brazing material 43 starts to melt, when the brazing material 43 completely melts and spreads over the welding parts of the copper parts 41, 42. Furthermore, the power feed time T1 is made the power feed time to the electrodes required until the movable electrode 32 reaches the second amount of displacement after reaching the first amount of displacement.

Furthermore, as the power feed time T1, to obtain statistical reliability, a large number of normal resistance brazing operations were performed for the case of a brazing material to obtain results similar to FIG. 6. Here, “normal resistance brazing” means resistance brazing performed in a state where the amount of heat generated is constant, the brazing material 43 is correctly interposed between the one copper part 41 and the other copper part 42, and the copper parts 41, 42 are correctly gripped between the pair of electrodes 31, 32.

Specifically, the apparatus of FIG. 1 with new replaced electrodes was used for a large number of resistance brazing operations to examine the first amount of displacement and second amount of displacement in the case of normal resistance brazing. From the thus obtained measurement data, the average value of the first amount of displacement, the average value of the second amount of displacement, and the average value of the power feed time T1 and its standard deviation were found.

Next, using the power feed time T1 to the working electrode 32 required from when reaching the first amount of displacement to when reaching the second amount of displacement, the lower limit threshold value Tb of the power feed time is set as follows. The lower limit threshold value Tb of the power feed time is the maximum value of the power feed time allowed when changing to a direction where the amount of heat generated increases. It is preferable that if receiving power feed of this time, the brazing material 43 can completely melt. Therefore, the apparatus 10 makes the lower limit threshold value Tb of the power feed time the average value of the power feed time T1 minus the standard deviation of the power feed time T1 times three.

In the same way, the upper limit threshold value Ta of the power feed time was set as follows. The upper limit threshold value Ta of the power feed time is the maximum value of the power feed time allowed when changing to a direction where the amount of heat generated decreases. It is preferably a time enabling the copper parts 41, 42 from being prevented from being unnecessarily deformed. Therefore, the apparatus 10 makes the upper limit threshold value Ta of the power feed time the value of the average value of the power feed time T1 plus the standard deviation of the power feed time T1 multiplied by four.

In the apparatus 10, by controlling the power feed time T1 to the lower limit threshold value Tb or more and the upper limit threshold value Ta or less in range, the amount of heat generated applied to the brazing material 43 can be kept within a predetermined range.

The average value of the first amount of displacement, the average value of the power feed time T1 and its standard deviation, the upper limit threshold value Ta of the power feed time, and the lower limit threshold value Tb of the power feed time found in the above way are stored using the input unit 15 in the power feed time measurement unit 12.

Further, returning to the explanation of FIG. 5, from the second half of the 30th cycle of FIG. 5, the amounts of displacement of the two become substantially constant. At this time, even with a brazing material, the brazing material 43 finishes melting completely. In this measurement, at the 35th cycle, the power feed to the electrodes is stopped. From then on, the heating is stopped. The deformation of the copper parts at a predetermined pressure also substantially ends, so the amount of displacement becomes constant. In FIG. 5, when the amount of displacement of the movable electrode 32 becomes 420 micronmeter, the application of pressure to the movable electrode 32 is stopped. That is, in the example of FIG. 5, the set amount of displacement is 420 micronmeter.

Note that in the case of use of a brazing material, the amount of displacement from the 10th cycle to the 35th cycle includes displacement due to melting of the brazing material 43 and displacement due to deformation of the copper parts. To make the welding by the resistance brazing more reliable, it is necessary to apply pressure to the copper parts 41, 42 to cause deformation even after the brazing material 43 has finished melting completely, so even after the brazing material 43 completely melts, the heating and pressure are continued to cause predetermined amounts of deformation at the copper parts 41, 42.

According to the above-mentioned apparatus 10, even if the contact resistance or other interelectrode resistance of the resistance brazing apparatus 30 changes, the amount of heat generated can be maintained constant during the resistance brazing. Specifically, it is possible to control the power feed time T required for the brazing material 34 to completely melt from the upper limit threshold value Ta or less to the lower limit threshold value Tb or more in range to keep the amount of heat generated within a predetermined range and keep the worked state of brazing constantly stable without brazing defects or crushing of the copper parts of the weld object.

Further, the apparatus 10 can be used to produce a copper product and thereby produce a good quality copper product.

Further, the control unit 11 of the apparatus 10 is used to select the program of the constant current source 33 and control the amount of heat generated, so even if the electrodes deteriorate, it is possible to change the current fed to the electrodes and keep the amount of heat generated constant, so it is possible to prolong the usage lifetime of the electrodes.

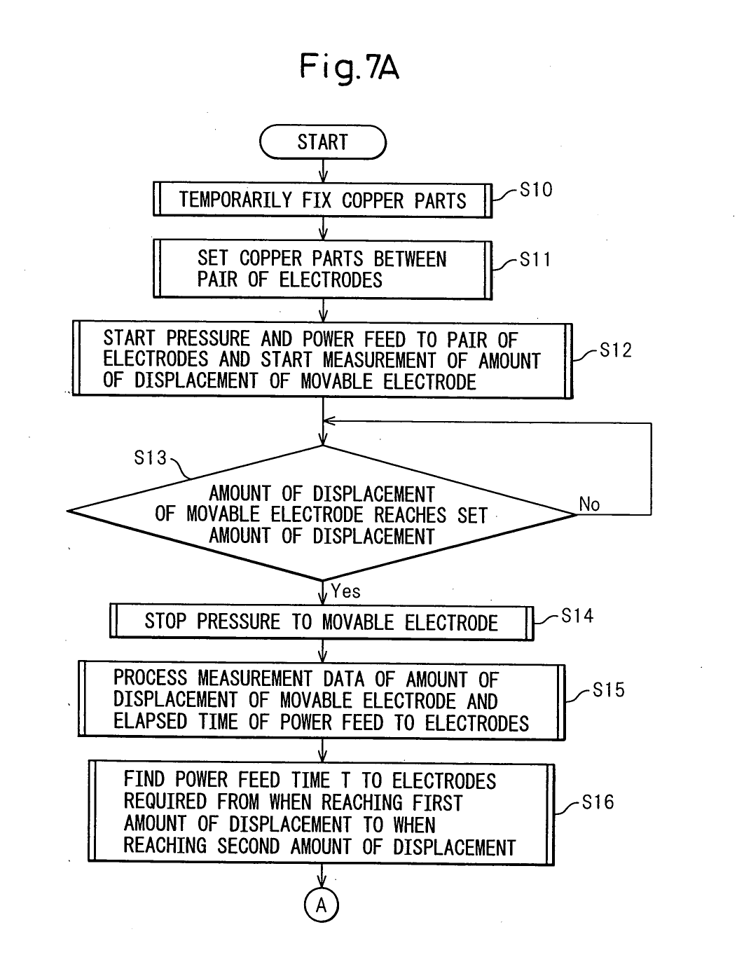

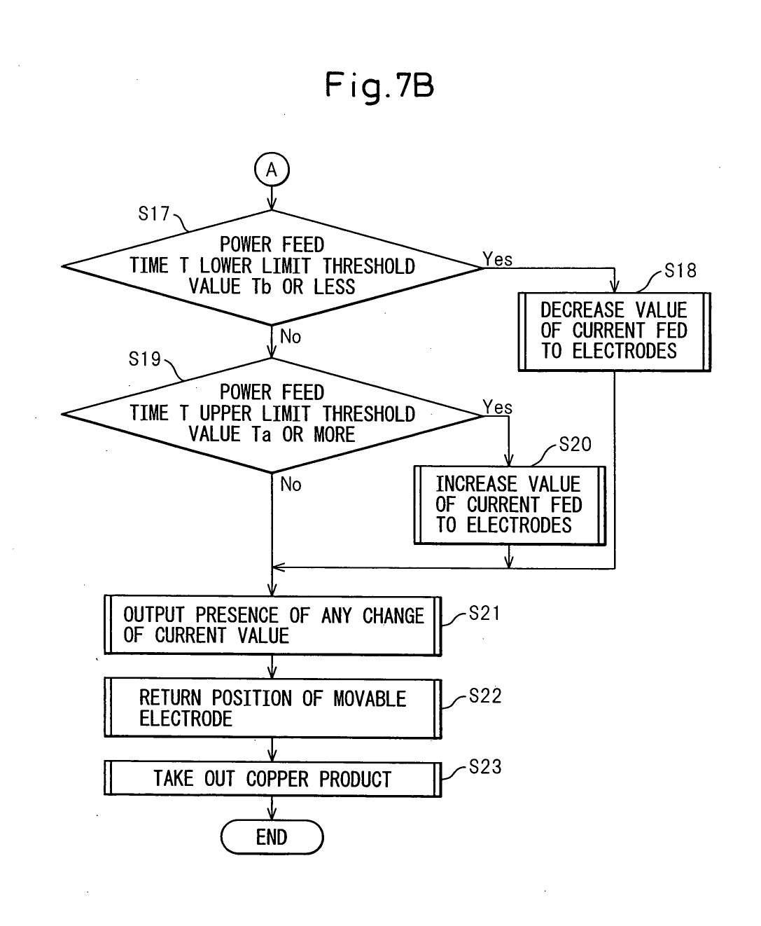

Next, an example of the method of control of resistance brazing of the present invention will be explained below with reference to FIG. 7 based on the preferred embodiments using the apparatus 10 for control of resistance brazing of the embodiment shown in the above-mentioned FIG. 1.

The present embodiment is a method of control of resistance brazing comprising gripping the copper parts 41, 42 of the weld object between which the brazing material 43 is interposed between the pair of electrodes 31, 32, applying pressure to the copper parts 41, 42, and feeding power to the electrodes 31, 32 in that state. It measures the power feed time T to the electrodes 31, 32 required from when an amount of displacement of a distance between the pair of electrodes 31, 32 reaches a first amount of displacement to when it reaches a second amount of displacement, decreases the amount of power feed to the pair of electrodes 31, 32 if the power feed time T is a lower limit threshold value Tb or less, and increases the amount of power feed to the pair of electrodes 31, 32 if the power feed time T is an upper limit threshold value Ta or more.

Below, the present embodiment will be explained further. FIG. 7A and FIG. 7B are flow charts showing an example of the operational routine of the apparatus 10 for control of resistance brazing of the present invention.

First, at step S10, the copper part 41 and the copper part 42 in the process of production of a copper product are temporarily attached by the brazing material 43.

Next, at step S11, the copper part 41 to which the copper part 42 is temporarily attached is detachably fastened to the fixed electrode 41 using a jig and the copper parts 41, 42 are set between the pair of electrodes 31, 32.

Next, at step S12, pressure and power start to be applied to the pair of electrodes 31, 32, and the displacement measurement device 17 is used to start measurement of the amount of displacement of the movable electrode 32. The pressurized movable electrode 32 starts to move from the initial position toward the fixed electrode 31.

Next, at step S13, it is judged if the amount of displacement of the movable electrode 32 has reached the set amount of displacement. If the amount of displacement of the movable electrodes 32 reaches the set amount of displacement, next, the routine proceeds to step S14. On the other hand, if the amount of displacement of the movable electrodes 32 does not reach the set amount of displacement, the routine returns to before S13.

Next, at step S14, the application of pressure to the movable electrode 32 is stopped. Note that the power feed to the electrodes is stopped right before the amount of displacement of the movable electrode 32 reaches the set amount of displacement.

Next, at step S15, the power feed time measurement unit 12 processes the measurement data of the amount of displacement of the movable electrode 32 and the elapsed time of power feed to the electrodes. Specifically, the power feed time measurement unit 12 extracts the elapsed times of power feed corresponding to the first amount of displacement and second amount of displacement from the stored measurement data.

Next, at step S16, the power feed time measurement unit 12 finds the power feed time T to the electrodes required from when the movable electrode 32 reaches the first amount of displacement to when it reaches the second amount of displacement from the elapsed times of power feed corresponding to the first amount of displacement and second amount of displacement extracted at S15.

Next, at step S17, the control unit 11 judges if the power feed time T is the lower limit threshold value Tb or less. If the power feed time T is the lower limit threshold value Tb or less, the routine proceeds to step S18. On the other hand, if the power feed time T is larger than the lower limit threshold value Tb, the routine proceeds to step S19.

Next, at step S18, the control unit 11 judges that the amount of heat generated has increased and decreases the value of the current fed to the electrodes. Specifically, as shown in FIG. 3(a) and FIG. 3(b), the control unit 11 changes the program built into the constant current source 33 from for example No. 3 to No. 4 to reduce the value of the current output. The control unit 11 stores the results of judgment. After that, the routine proceeds to step S21.

On the other hand, when the routine proceeds from S17 to step S19, the control unit 11 judges if the power feed time T is the upper limit threshold value Ta or more. If the power feed time T is the upper limit threshold value Ta or more, the routine proceeds to step S20. On the other hand, if the power feed time T is smaller than the upper limit threshold value Ta, the routine proceeds to step S21.

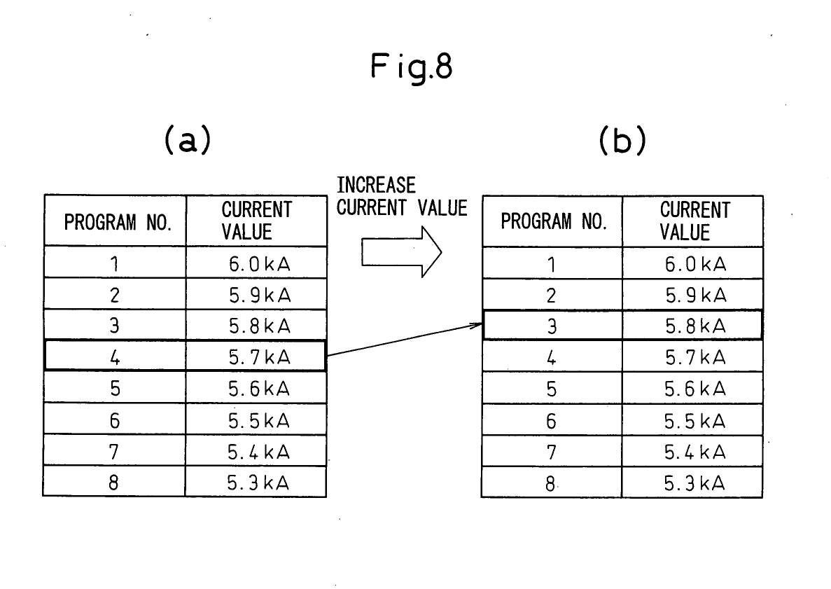

Next, at step S20, the control unit 11 judges that the amount of heat generated has decreased and increases the value of the current fed to the electrodes. Specifically, as shown in FIG. 8(a) and FIG. 8(b), it changes the program built into the constant current source 33 from for example No. 4 to No. 3 to increase the value of the current output. The control unit 11 stores the results of the judgment. After that, the routine proceeds to before step S21.

Next, at step S21, the control unit 11 outputs the results of judgment from the output unit 15.

Next, at step S22, the movable electrode 32 is returned to the initial position to enable the resistance brazed copper product to be detached from the fixed electrode 31.

Next, at step S23, the resistance brazed copper product is detached from the fixed electrode 31. Further, when, based on the result of judgment output from the output unit 15, the amount of heat generated is not in the predetermined range, the detached copper product is removed from the process as a defective product.

The method and apparatus for controlling resistance brazing and the method of production of a copper product of the present invention are not limited to the above-mentioned embodiment. They may be suitably modified so long as not departing from the gist of the present invention.

For example, in the above embodiment of the present invention, the first amount of displacement of the movable electrode 32 corresponded to the time when the brazing material 43 started to melt and the second amount of displacement corresponded to the time when the brazing material 43 completely melted and spread over the welding parts of the copper parts 41, 42, but so long as it is possible to control the amount of heat generated constant, the first amount of displacement or second amount of displacement may be made to correspond to other times as well.

Further, the average value of the first amount of displacement, the average value of the second amount of displacement, the average value of the power feed time T1 and its standard deviation, the upper limit threshold value Ta of the power feed time, and the lower limit threshold value Tb of the power feed time are preferably suitably set by the value of the current fed to the electrodes, the electrodes used, the weld object to be resistance brazed, and the copper product produced.

Further, in the above embodiment, the weld object was a flat plate shaped copper part and a bar shaped copper part, but the weld object may also be a tube shaped copper part and bar shaped copper part. Furthermore, the resistance brazing may be resistance brazing of the bar shaped copper part to the inside surface of the tube shaped copper part.

Further, in the above embodiment, whether the amount of heat generated was in the predetermined range was judged before returning the position of the movable electrode 42, but whether the brazing material was arranged or not may be judged anytime before detaching the copper product from the fixed electrode 31.

Further, in the above-mentioned method and apparatus for control of resistance brazing, copper parts were used as the weld object, but it is also possible to use another weld object so long as it is a weld object which can be resistance brazed.

Further, the above-mentioned embodiment, the control unit 11 selected the program of the constant current source 33 and set the value of the current output, but it is also possible for the control unit 11 to directly control a feedback signal for controlling the output current inside the constant current source 33 to change the value of the current output by the constant current source 33.

What is claimed is:

1. A method of control of resistance brazing comprising gripping parts of a weld object between which a brazing material is interposed between a pair of electrodes, applying pressure to the parts of the weld object, and applying power to said electrodes in that state,
which method comprises
measuring a power feed time to said electrodes required from when an amount of displacement of a distance between a pair of said electrodes reaches a first amount of displacement to when it reaches a second amount of displacement,
decreasing the amount of power feed to the pair of electrodes when the power feed time is a lower limit threshold value or less, and,
increasing the amount of power feed to the electrodes when the power feed time is the upper limit threshold value or more.

2. A method of control of resistance brazing as set forth in claim 1, wherein said first amount of displacement corresponds to the time when said brazing material starts to melt, while said second amount of displacement corresponds to the time when said brazing material completely melts and spreads over the welding parts of the parts of the weld object.

3. A method of control of resistance brazing as set forth in claim 1, wherein said lower limit threshold value is made the value of an average value of said power feed time found by performing resistance brazing with said brazing material interposed between parts of the weld object a plurality of times minus the value of the standard deviation of said power feed time multiplied by three.

4. A method of control of resistance brazing as set forth in claim 1, wherein said upper limit threshold value is made the value of an average value of said power feed time found by performing resistance brazing with said brazing material interposed between parts of the weld object a plurality of times plus the value of the standard deviation of said power feed time multiplied by four.

5. A method of control of resistance brazing as set forth in claim 1, further controlling the value of the current flowing through the pair of electrodes to control the amount of heat generated.

6. A method of control of resistance brazing as set forth in claim 1, wherein
the pair of electrodes is comprised of a fixed electrode and a movable electrode, and
the power feed time to the electrodes required from when the amount of displacement of said movable electrode reaches said first amount of displacement to when it reaches said second amount of displacement is measured.

7. An apparatus for control of resistance brazing which grips parts of a weld object between which a brazing material is interposed between a pair of electrodes, applies pressure to the parts of the weld object, and feeds power to said electrodes in that state for resistance brazing, including
a power feed time measurement unit measuring a power feed time to said electrodes required from when an amount of displacement of a distance between said pair of electrodes reaches a first amount of displacement to when it reaches a second amount of displacement and
a control unit decreasing the amount of power feed to the pair of electrodes when the power feed time is a lower limit threshold value or less and increasing the amount of power feed to the electrodes when the power feed time is the upper limit threshold value or more.

8. A method of production of a copper product gripping copper parts between which a brazing material is interposed between a pair of electrodes, applying pressure to the copper parts, and feeding power to said electrodes in that state for resistance brazing,
comprising using the method of control of the resistance brazing as set forth in claim 1 during resistance brazing.
